(19) United States
(12) Patent Application Publication
(10) Pub. No.: US 2013/0329177 A1
(43) Pub. Date: Dec. 12, 2013

(54) LIQUID-CRYSTAL DISPLAY

(71) Applicant: InnoLux Corporation, Chu-Nan (TW)

(72) Inventors: Chih-Yung HSIEH, Jhu-Nan (TW); Ying-Jen CHEN, Jhu-Nan (TW); Yi-Hsin CHEN, Jhu-Nan (TW); Yi-Da HUANG, Jhu-Nan (TW); Wei-Jean LIU, Jhu-Nan (TW)

(21) Appl. No.: 13/911,723

(22) Filed: Jun. 6, 2013

(30) Foreign Application Priority Data
Jun. 8, 2012 (TW) 101120614

(51) Int. Cl. G02F 1/1343

(52) U.S. Cl. CPC G02F 1/134309
USPC 349/141

(57) ABSTRACT

A liquid-crystal display is provided, including: a first substrate including a plurality of electrode units, wherein each of the electrode units includes a pixel electrode having a first edge adjacent to a second edge and a plurality of finger-type electrodes connected to the first edge of the pixel electrode; a second substrate having an opposite electrode overlapping the plurality of electrode units, wherein the opposite electrode includes a hollow pattern, including: at least one first main slit and at least one second main slit intersecting with each other, wherein the second main slit intersects the second edge at a first intersection, and the first edge intersects the second edge at a second intersection, and a distance along the second edge and between the first and second intersections is smaller than about 10 nm; and a liquid-crystal layer interposed between the first and second substrates.

### CROSS REFERENCE TO RELATED APPLICATIONS

This Application claims priority of Taiwan Patent Application No.101120614, filed on Jun. 8, 2012, the entirety of which is incorporated by reference herein.

### FIELD OF THE INVENTION

The present disclosure relates to a liquid-crystal display. More particularly, the present disclosure relates to a liquid-crystal display which may improve grey level inversion.

### DESCRIPTION OF THE RELATED ART

A liquid-crystal display is an imaging device that displays images by controlling light flux. A conventional twisted nematic (TN) liquid-crystal display has good transmittance performance, but the viewing angle thereof is narrow due to the structure and optical properties of TN type liquid crystals.

Thus, a vertical alignment (VA) type wide viewing angle LCD has been developed, which has good transmittance performance with a wide viewing angle. Examples of VA type LCDs are a patterned vertical alignment (PVA) type LCD, and a multi-domain vertical alignment (MVA) type LCD. The PVA type LCD achieves wide viewing angle characteristics by applying a fringing-field effect and optical compensation films. The MVA type LCD widens the viewing-angle and improves transmittance of the liquid-crystal display by dividing a pixel area into multi domains and tilting liquid crystals in the multi domains in several different directions using protrusion features or specific patterns.

However, the current VA type LCD still has shortcomings that need to be addressed. Referring to FIG. 1, a top view of a liquid-crystal layer of a VA type LCD 100 according to the known art is illustrated. When a voltage is applied to the electrodes, liquid-crystal molecules 102 and 106 tilt, respectively, in horizontal directions 120 and 130, and the liquid-crystal molecules 102 and 104 which are arranged in a direction parallel to an electric field (such as parallel to the normal line of the paper) tilt in the same horizontal direction, such as the horizontal direction 120, without a horizontal twist. Thus, light cannot penetrate through the liquid-crystal molecules 102 and 104 since they are tilted in the same horizontal direction, and therefore the transmittance of the VA type LCD is reduced. In theory, the LCD has 255 grey levels, and higher grey levels have higher brightness. However, it has been observed that higher grey levels often lead to brightness which is lower than corresponding lower grey levels when a large viewing angle is provided. The black-white inversion phenomenon is called grey level inversion.

A technique which adds a chiral dopant to the liquid-crystal layer was developed to solve the aforementioned problems. For example, referring to FIG. 2, a top view of a liquid-crystal layer of a VA type LCD that includes the chiral dopant is illustrated. When a voltage is applied to the electrodes, the liquid-crystal molecules 202 and 206, respectively, tilt in horizontal directions 220 and 230, and the liquid-crystal molecules 202 and 204 which are arranged in a direction parallel to the electric field (such as the direction through the paper) also have different horizontal twists. Accordingly, light can penetrate through the liquid-crystal layer by the birefringence of the liquid-crystal molecules 202 and 204. In addition, optical dark fringes resulting from the liquid-crystal molecules which are not tilted or tilted in undesired directions can be narrowed or disappeared, thus improving grey level inversion.

Although the grey level inversion can be improved by doping the chiral dopant to the liquid-crystal layer, grey level inversion still remains, and is particularly obvious at edges of pixel units. Accordingly, a new technique for improving transmittance and preventing grey level inversion for LCDs is needed.

### BRIEF SUMMARY OF THE INVENTION

The present disclosure provides a liquid-crystal display, comprising: a first substrate comprising a plurality of electrode units, wherein each of the plurality of electrode units comprises a pixel electrode having a first edge adjacent to a second edge and a plurality of finger-type electrodes connected to the first edge of the pixel electrode; a second substrate having an opposite electrode overlapping the plurality of electrode units, wherein the opposite electrode comprises a hollow pattern, comprising: at least one first main slit and at least one second main slit intersecting with each other, wherein the second main slit intersects the second edge at a first intersection, and the first edge intersects the second edge at a second intersection, and a distance along the second edge and between the first intersection and the second intersection is smaller than about 10 nm; and a liquid-crystal layer interposed between the first substrate and the second substrate.

The present disclosure also provides a liquid-crystal device, comprising: a first substrate comprising a plurality of electrode units, wherein each of the plurality of electrode units includes a pixel electrode having a first edge adjacent to a second edge and a plurality of finger-type electrodes connected to the first edge of the pixel electrode, wherein the first edge is a bent line; a second substrate having an opposite electrode overlapping the plurality of electrode units; and a liquid-crystal layer interposed between the first substrate and the second substrate.

The present disclosure further provides a liquid-crystal display, comprising: a first substrate comprising a plurality of electrode units, wherein each of the electrode units comprises a pixel electrode having a first edge adjacent to a second edge and a plurality of finger-type electrodes connected to the first edge of the pixel electrode; a second substrate having an opposite electrode overlapping the plurality of electrode units, wherein the opposite electrode comprises a hollow pattern, comprising: at least one first main slit and at least one second main slit intersecting with each other, wherein an extended line of the second main slit intersects the second edge at a first intersection, and the first edge intersects the second edge at a second intersection, and a distance along the second edge and between the first intersection and the second intersection is smaller than about 10 nm; and a liquid-crystal layer interposed between the first substrate and the second substrate.

### BRIEF DESCRIPTION OF THE DRAWINGS

The invention will now be described, by way of example, with reference to the accompanying drawings, in which:

FIG. 1 shows a top view of a liquid-crystal layer of an LCD according to known art.

FIG. 2 shows a top view of a liquid-crystal layer of a VA type LCD according to known art.

FIG. 3 shows a cross-sectional view of an LCD according to an embodiment of the present disclosure.

FIGS. 4-8 show top views of electrode patterns of LCDs according to some embodiments of the present disclosure.

FIG. 9 shows experimental images of the pixel units according to various electrode patterns.

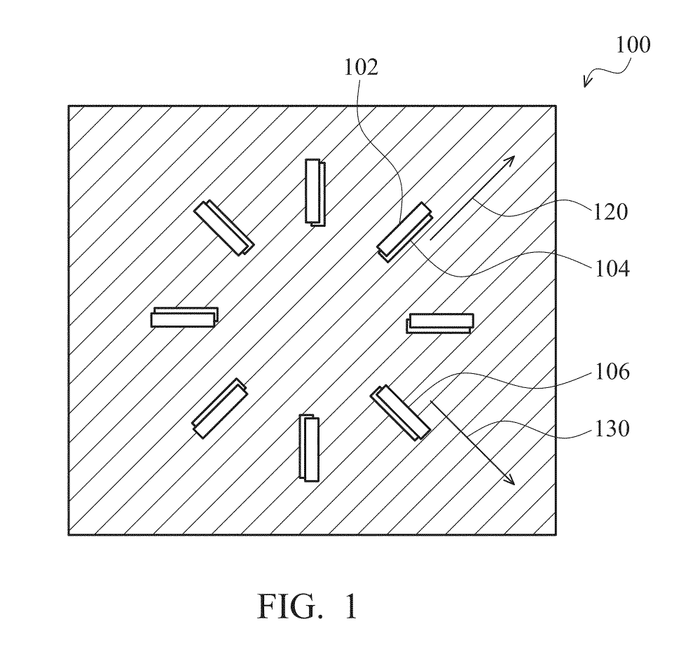

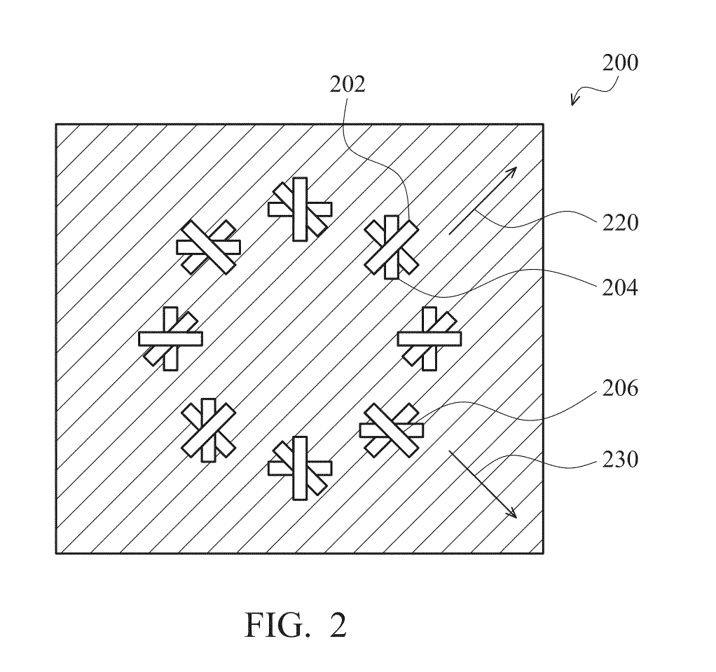

### DETAILED DESCRIPTION OF THE INVENTION

The following description is of the best-contemplated mode of carrying out the invention. This description is made for the purpose of illustrating the general principles of the invention and should not be taken in a limiting sense. For example, the formation of a first feature over, above, below, or on a second feature in the description that follows may include embodiments in which the first and second features are formed in direct contact, and may also include embodiments in which additional features may be formed between the first and second features, such that the first and second features may not be in direct contact. The scope of the invention is best determined by reference to the appended claims.

It should be understood that although the terms first, second, third, etc., may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. For example, a first element, component, region, layer, and/or section could be termed a second element, component, region, layer, and/or section without departing from the teachings of the example embodiments.

In the following disclosure, specific embodiments of a liquid-crystal display are provided, wherein the optical dark fringes occurring at the long edge of pixel units can be hindered. In addition, the term “pixel units” may be referred to any one of blue pixel units, green pixel units and red pixel units.

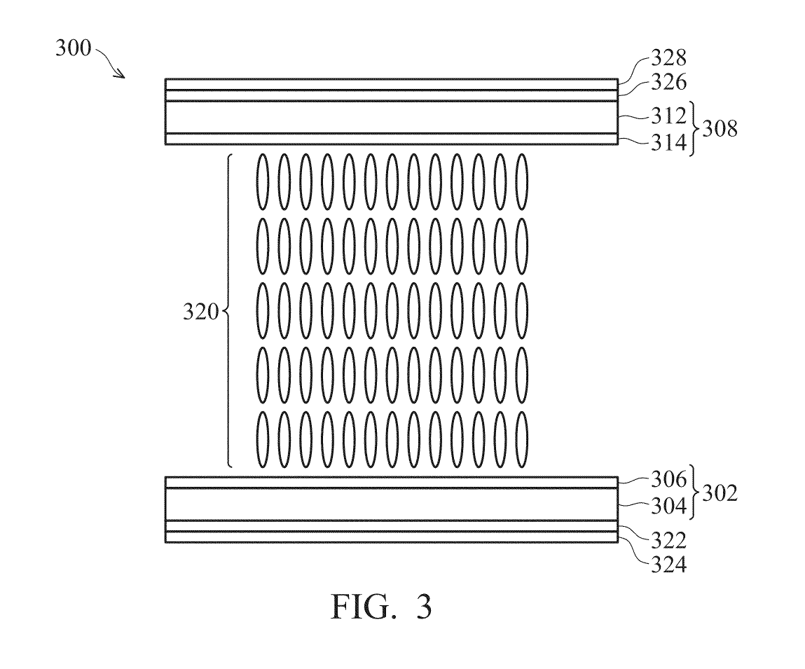

FIG. 3 shows a cross-sectional view of a liquid-crystal display (LCD) 300 according to an embodiment of the present disclosure. The LCD 300 may be a vertical alignment (VA) type LCD. As shown in FIG. 3, the LCD 300 may comprise a first substrate 302 and a second substrate 308 opposite and parallel to each other. In an embodiment, the first substrate 302 may be a thin-film transistor (TFT) substrate comprising a base substrate with at least one pixel unit. Each of the pixel units may comprise a pixel electrode 306 and a TFT (not shown) disposed on a base substrate 304. In an embodiment, the substrate 304 may be such as a glass substrate. A black matrix (not shown) may be disposed between each pixel unit.

The second substrate 308 may be a color filter substrate comprising a substrate 312, an opposite electrode 314 and a color filter (not shown). A black matrix (not shown) may be disposed between each color filter.

In an embodiment, the LCD 300 may further comprise a first compensation film 322 and a first polarizer 324 disposed under the first substrate 302. The LCD 300 may further comprise a second compensation film 326 and a second polarizer 328 disposed over the second substrate 308. In some embodiments, polarization axes of the first polarizer 324 and the second polarizer 328 are perpendicular to each other.

A liquid-crystal layer 320 of the LCD 300 may be interposed between the first substrate 302 and the second substrate 308. In an embodiment, the liquid-crystal layer 320 may comprise a twisted nematic liquid-crystal material, for example a negative nematic liquid-crystal or a positive nematic liquid crystal. In an embodiment, chiral active substances, such as chiral dopants, are added in the liquid-crystal layer 320. Thus, the liquid-crystal molecules of the liquid-crystal layer 320 may twist along an axis, thereby having optical activity, and the axis is parallel to a normal line of the first substrate 302.

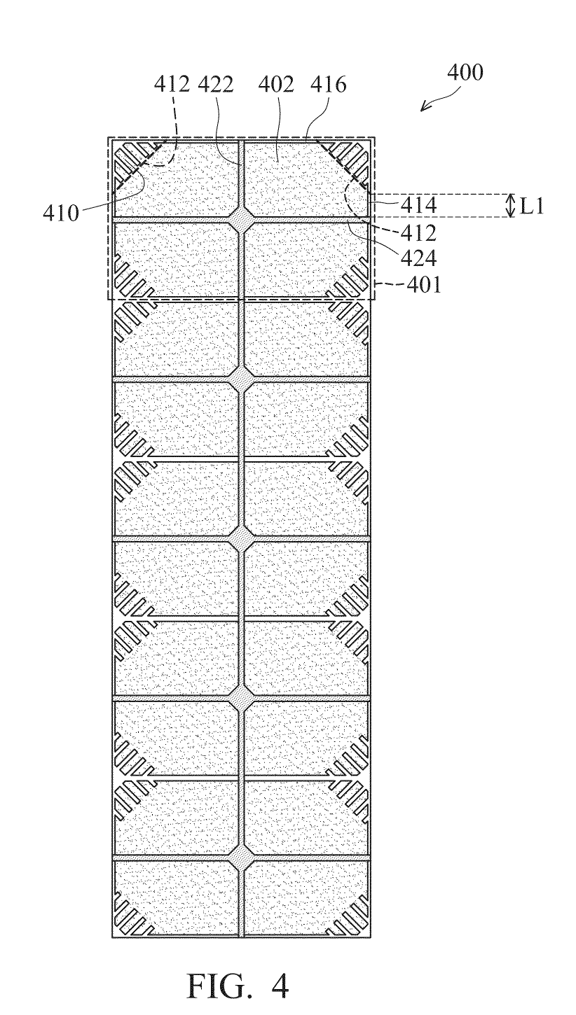

FIG. 4 shows a top view of an electrode pattern of the LCD according to an embodiment of the present disclosure. In FIG. 4, an overlapping pattern of an electrode pattern of the pixel electrode 306 of a pixel unit 400 and an electrode pattern of the opposite electrode 314 is illustrated. Reference may be made to FIG. 3 for the cross-sectional view of the LCD.

Referring to FIG. 4, the pixel unit 400 may comprise a plurality of electrode units 401, and each of the plurality of electrode units 401 may comprise a pixel electrode 402 and a plurality of finger-type electrodes 410. As illustrated in FIG. 4, the pixel electrodes 402 of each of the plurality of electrode units 401 are electrically connected to each other. The pixel electrode 402 may comprise a first edge 412, a second edge 414 and a third edge 416. The first edge 412 is between and connected to the second edge 414 and the third edge 416. For example, the first edge 412 may have the included angle of about 135° with the second edge 414 and the third edge 416, respectively. The plurality of finger-type electrodes 410 are connected to the first edge 412 of the pixel electrode 402. In an embodiment, the first edge 412 may be a straight line. A fringing electric field occurs due to the pattern design of the plurality of finger-type electrodes 410, thereby enhancing the ability of the pixel electrode 406 to control the liquid-crystal layer; especially for the liquid-crystal layer comprising chiral dopants.

The opposite electrode 314 overlaps the plurality of electrode units 401. The opposite electrode 314 (shown as transparent except the hollow pattern) may comprise a hollow pattern. The hollow pattern may comprise at least one first main slit 422 and at least one second main slit 424 intersecting with each other. In an embodiment, the at least one first main slit 422 intersects the third edge 416, and the at least one second main slit 424 intersects the second edge 414. In an embodiment, an extended line of the first main slit 422 intersects the third edge 416, and an extended line of the second main slit 424 intersects the second edge 414. In some embodiments, first to four quadrants may be divided by the at least one first main slit 422 and the at least one second main slit 424. For example, the first quadrant may be an area defined at the right side of the first main slit 422 and the upper side of the second main slit 424. The second quadrant may be an area defined at the left side of the first main slit 422 and the upper side of the second main slit 424. The third quadrant may be an area defined at the left side of the first main slit 422 and the lower side of the second main slit 424. The fourth quadrant may be an area defined at the right side of the first main slit 422 and the lower side of the second main slit 424. In an embodiment, the plurality of finger-type electrodes 410 in the first to fourth quadrants may extend along 45°, 135°, 225° and 315° angles, respectively.

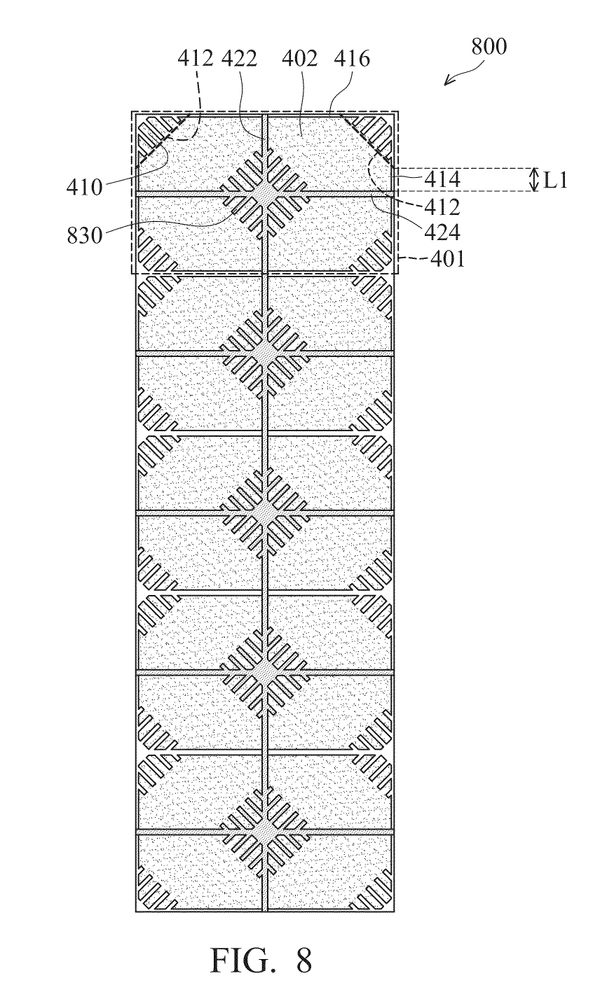

Referring to FIG. 8, in an optional embodiment, the hollow pattern may further comprise a plurality of finger-type slits 830 for enhancing the ability of the opposite electrode to control the liquid-crystal layer. Each of the plurality of finger-type slits 830 may have an end connected to one of the first main slit 422 and the second main slit 424. In addition, the plurality of finger-type slits 830 may extend along 45°, 135°, 225° and 315° angles, in the first to fourth quadrants, respectively.

Optical dark fringes are prone to occur at the edges of the pixel units 400, for example, the second edge 414 of the pixel units 400. However, after experimentation, it was found that the optical dark fringes in the pixel units 400 may be eliminated by shortening the distance L1 along the second edge 414 and between a first intersection of the second main slit 424 and the second edge 414 and a second intersection of the first edge 412 and the second edge 414 to a specific value. For example, the distance L1 may be less than about 10 μm. In another embodiment, the distance L1 may be less than about 7 μm, or in particular, less than about 5 μm. In some embodiments in which the second main slit 424 does not extend to intersect with the second edge 414, the optical dark fringes also may be eliminated by shortening the distance along the second edge 414 and between a first intersection of an extended line of the second main slit 424 and the second edge 414 and a second intersection of the first edge 412 and the second edge 414 to a specific value equal to that of the distance L1.

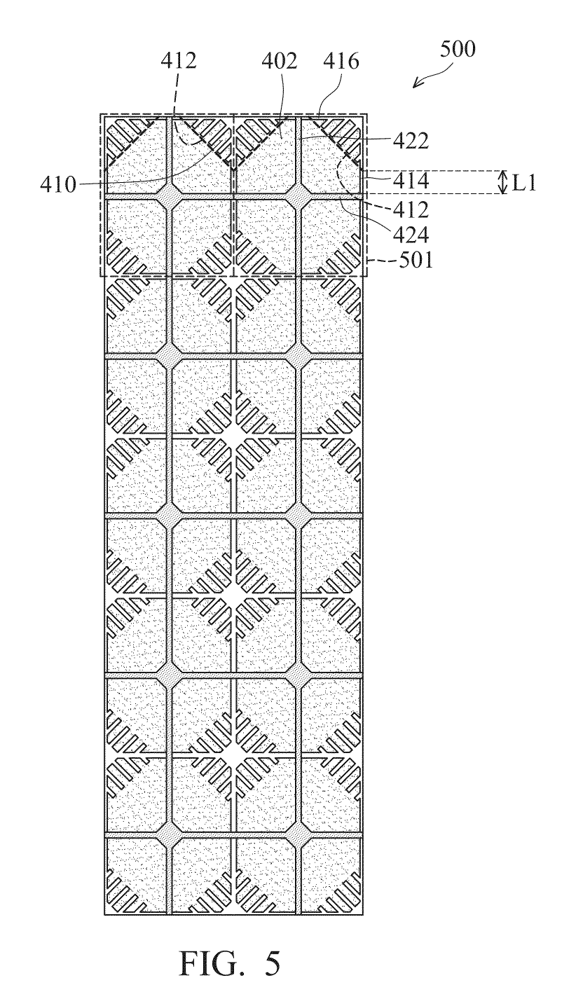

FIG. 5 shows a top view of an electrode pattern of the LCD according to another embodiment of the present disclosure. In FIG. 5, an overlapping pattern of an electrode pattern of the pixel electrode 306 of a pixel unit 500 and an electrode pattern of the opposite electrode 314 is illustrated. Reference may be made to FIG. 3 for the cross-sectional view of the LCD. In this embodiment, like reference numerals are used to indicate elements substantially similar to the elements described in the previous embodiments.

In this embodiment, the pixel electrodes 402 of each of the plurality of electrode units 501 are in electrical series connection or in electrical parallel connection.

In this embodiment, the distance L1 may be less than about 10 μm. Alternatively, the distance L1 may be less than about 7 μm, or in particular, less than about 5 μm.

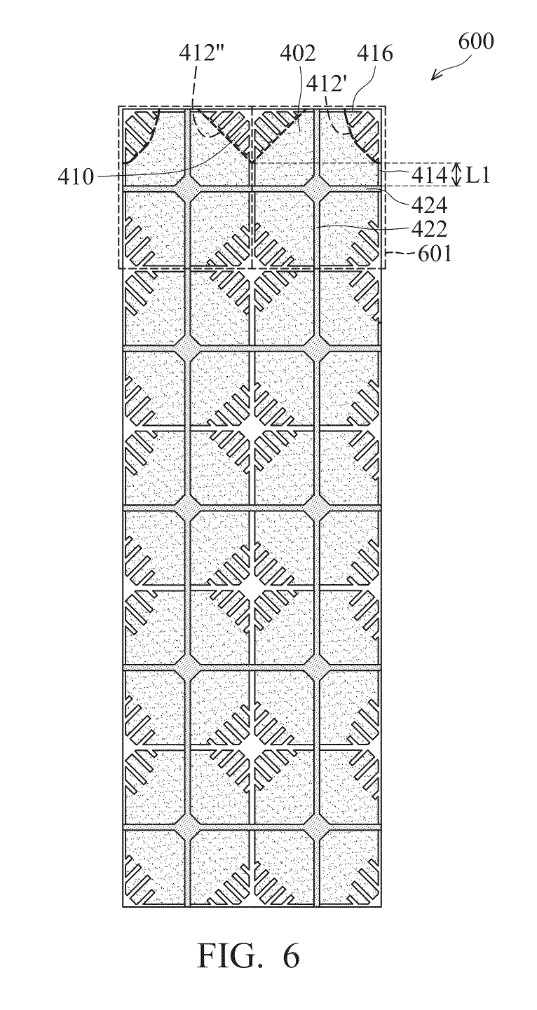

FIG. 6 shows a top view of an electrode pattern of the LCD according to yet embodiment of the present disclosure. In FIG. 6, an overlapping pattern of an electrode pattern of the pixel electrode 306 of a pixel unit 600 and an electrode pattern of the opposite electrode 314 is illustrated. Reference may be made to FIG. 3 for the cross-sectional view of the LCD. In this embodiment, like reference numerals are used to indicate elements substantially similar to the elements described in the above embodiments.

In this embodiment, the first edge near the outer edge of the pixel unit is designed to be a bent line and the first edge near the center of the pixel unit is designed to be a straight line, for a better transmittance. Referring to FIG. 6, in each electrode unit 601, the first edge 412′ of a side of the electrode unit 601 (e.g., the first edge near the outer edge of the pixel unit 600) may be a bent line, and the first edge 412″ of another side of the electrode unit (e.g., the first edge near the center of the pixel unit 600) may be a straight line. In an embodiment, the included angle between the first edge 412′ and the third edge 416 may be less than the included angle between the first edge 412′ and the second edge 414. For example, the included angle between the first edge 412′ and the third edge 416 may be less than about 135°. In some embodiments, the slope of the first edge 412′ may be varied uncontinuously. On the other hand, since the first edge 412″ is a straight line, it may have the included angle of about 135° with the second edge 414 and the third edge 416, respectively. In this embodiment, the pixel electrode 402 may have a larger area and better transmittance because the first edge 412′ is a bent line. In addition, the distance L1 can also be maintained to be less than about 10 μm, or less than about 7 μm, or 5 μm, for eliminating the optical dark fringes.

In this embodiment, the plurality of finger-type electrodes 410 may be connected to the first edge 412′ and the first edge 412″ and extend along 45°, 135°, 225° and 315° angles in the first to fourth quadrants, respectively. The hollow pattern of the opposite electrode may optionally comprise a plurality of finger-type slits (not shown).

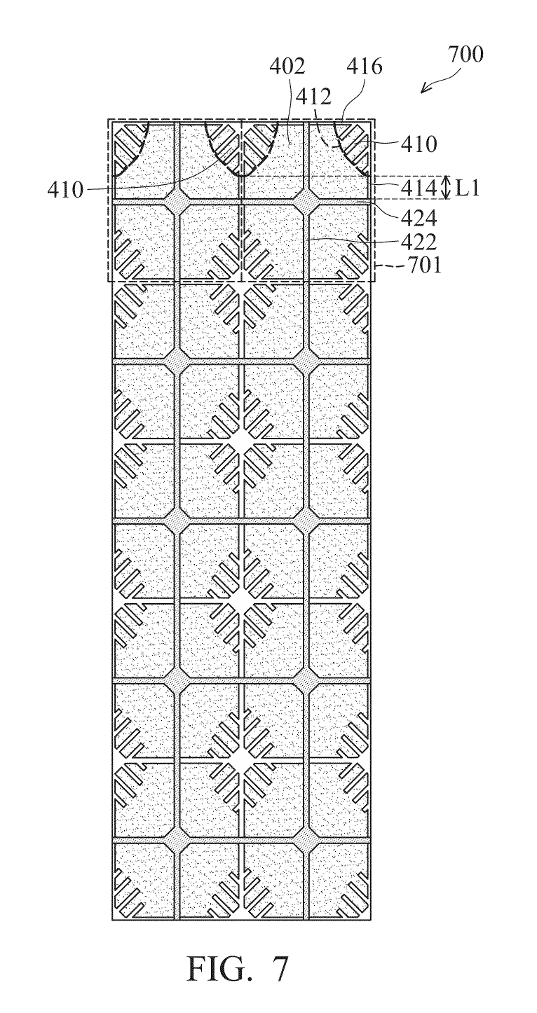

FIG. 7 shows a top view of an electrode pattern of the LCD according to yet embodiment of the present disclosure. In FIG. 7, an overlapping pattern of an electrode pattern of the pixel electrode 306 of a pixel unit 700 and an electrode pattern of the opposite electrode 314 is illustrated. Reference may be made to FIG. 3 for the cross-sectional view of the LCD. In this embodiment, like reference numerals are used to indicate elements substantially similar to the elements described in the above embodiments.

In this embodiment, the electrode pattern may be substantially same with the electrode pattern shown in FIG. 6, except each of the first edges 412 of the pixel units 701 is a bent line for better transmittance. In this embodiment, the distance L1 can also be maintained to be less than about 10 nm, or less than about 7 nm, or 5 nm.

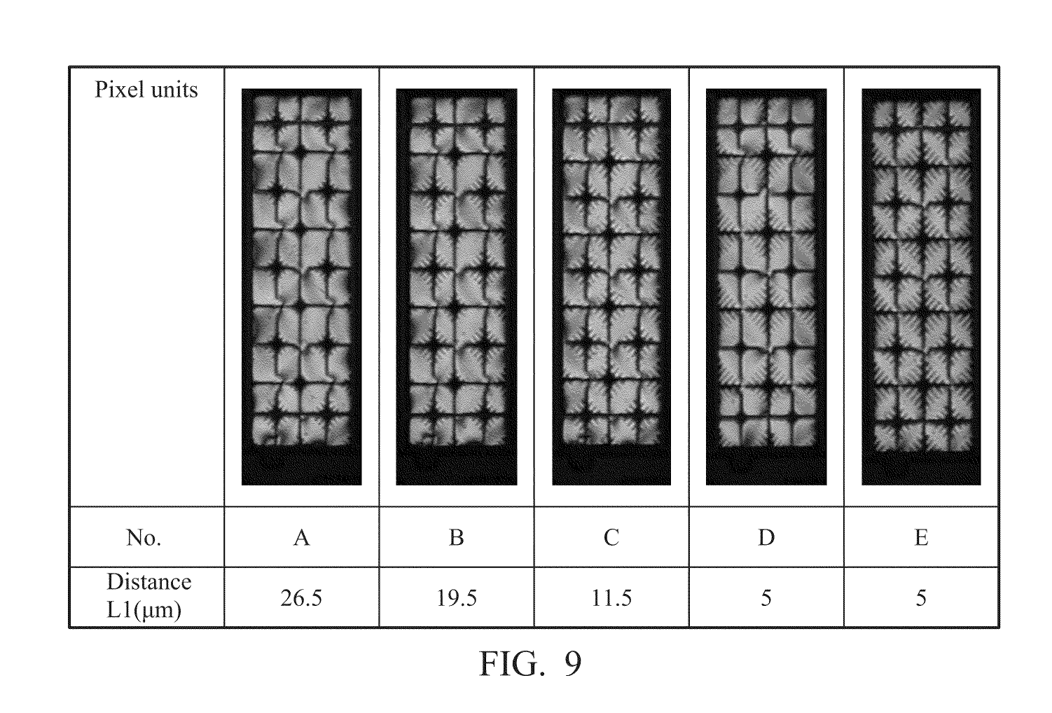

FIG. 9 shows experimental images of the pixel units according to various electrode patterns. In this figure, No. A to E represent LCDs having similar pixel electrode patterns and opposite electrode patterns, but with different distances L1. The distance L1 is a distance along the second edge and between the intersection of the second main slit and the second edge and the intersection of the first edge and the second edge. As shown in FIG. 9, the LCDs of No. A to C have the distances L1 of greater than about 10 nm, thereby showing obvious horn-like optical dark fringes occurring near the second edge of the pixel units. In contrast, the LCDs of No. D to E have shortened distances L1, thereby showing no obvious horn-like optical dark fringes in the pixel units, whether the hollow pattern of the opposite electrode includes or doesn't include the plurality of finger-type slits.

While the preferred embodiments of the invention have been described above, it will be recognized and understood that various modifications can be made to the invention and the appended claims are intended to cover all such modifications which may fall within the spirit and scope of the invention.

What is claimed is:

1. A liquid-crystal display, comprising:
a first substrate comprising a plurality of electrode units, wherein each of the electrode units comprises a pixel electrode having a first edge adjacent to a second edge and a plurality of finger-type electrodes connected to the first edge of the pixel electrode;
a second substrate having an opposite electrode overlapping the plurality of electrode units, wherein the opposite electrode comprises a hollow pattern, comprising:
at least one first main slit and at least one second main slit intersecting with each other, wherein the second main slit intersects the second edge at a first intersection, and the first edge intersects the second edge at a second intersection, and a distance along the second edge and between the first intersection and the second intersection is smaller than about 10 nm; and
a liquid-crystal layer interposed between the first substrate and the second substrate.

2. The liquid-crystal display according to claim 1, wherein the distance along the second edge and between the first intersection and the second intersection is smaller than about 5 nm.

3. The liquid-crystal display according to claim 1, wherein the first to fourth quadrants are divided by the first main slit and the second main slit, and the a plurality of finger-type electrodes in the first to fourth quadrants are extended along 45°, 135°, 225° and 315° angles, respectively.

4. The liquid-crystal display according to claim 1, wherein the first edge comprises a straight line, a bent line or a combination thereof

5. The liquid-crystal display according to claim 4, wherein the pixel electrode further comprises a third edge, and the first edge is between and connected to the third edge and the second edge, and the included angle between the first edge and the third edge is smaller than the included angle between the first edge and the second edge, when the first edge is the bent line.

6. The liquid crystal display according to claim 5, wherein the included angle between the first edge and the third edge is smaller than 135°.

7. The liquid-crystal display according to claim 1, wherein the liquid-crystal layer comprises a chiral dopant added therein.

8. A liquid-crystal display, comprising:
a first substrate comprising a plurality of electrode units, wherein each of the plurality of electrode units comprises a pixel electrode having a first edge adjacent to a second edge and a plurality of finger-type electrodes connected to the first edge of the pixel electrode, wherein the first edge is a bent line;
a second substrate having an opposite electrode overlapping the plurality of electrode units; and
a liquid-crystal layer interposed between the first substrate and the second substrate.

9. The liquid-crystal display according to claim 8, wherein the opposite electrode comprises a hollow pattern comprising at least one first main slit and at least one second main slit intersecting with each other, and the second main slit intersects the second edge at a first intersection, and the first edge intersects the second edge at a second intersection, and a distance along the second edge and between the first intersection and the second intersection is smaller than about 10 μm.

10. The liquid-crystal display according to claim 9, wherein the distance along the second edge and between the first intersection and the second intersection is smaller than about 5 μm.

11. The liquid-crystal display according to claim 8, wherein the opposite electrode comprises a hollow pattern comprising at least one first main slit and at least one second main slit intersecting with each other, and an extended line of the second main slit second edge at a second intersection, and a distance along the second edge and between the first intersection and the second intersection is smaller than about 10 μm.

12. The liquid-crystal display according to claim 8, wherein the first to fourth quadrants are divided by the first main slit and the second main slit, and the a plurality of finger-type electrodes in the first to fourth quadrants are extended along 45°, 135°, 225° and 315° angles, respectively.

13. The liquid-crystal display according to claim 8, wherein the pixel electrode further comprises a third edge, and the first edge is between and connected to the third edge and the second edge, and the included angle between the first edge and the third edge is smaller than the included angle between the first edge and the second edge.

14. The liquid-crystal display according to claim 13, wherein the included angle between the first edge and the third edge is smaller than 135°.

15. The liquid-crystal display according to claim 8, wherein the liquid-crystal layer comprises a chiral dopant added therein.

16. A liquid-crystal display, comprising:
a first substrate comprising a plurality of electrode units, wherein each of the electrode units comprises a pixel electrode having a first edge adjacent to a second edge and a plurality of finger-type electrodes connected to the first edge of the pixel electrode;
a second substrate having an opposite electrode overlapping the plurality of electrode units, wherein the opposite electrode comprises a hollow pattern, comprising:
at least one first main slit and at least one second main slit intersecting with each other, wherein an extended line of the second main slit intersects the second edge at a first intersection, and the first edge intersects the second edge at a second intersection, and a distance along the second edge and between the first intersection and the second intersection is smaller than about 10 μm; and
a liquid-crystal layer interposed between the first substrate and the second substrate.
